(19) United States
(12) Patent Application Publication
(10) Pub. No.: US 2019/0349501 A1
(43) Pub. Date: Nov. 14, 2019

(54) HALFTONE SCREENS ASSOCIATED WITH MOIRÉ EFFECTS BELOW A THRESHOLD

(71) Applicant: HP Indigo B.V., Amstelveen (NL)

(72) Inventors: Oren Haik, Ness Ziona (IL); Tal Frank, Ness Ziona (IL); Yotam Ben-Shoshan, Ness Ziona (IL)

(73) Assignee: HP Indigo B.V., Amstelveen (NL)

(21) Appl. No.: 16/465,299

(22) PCT Filed: Feb. 13, 2017
(86) PCT No.: PCT/EP2017/053149

§ 371 Date: May 30, 2019

(51) Int. Cl. H04N 1/52; H04N 1/405; G06K 15/02

(52) U.S. Cl. CPC H04N 1/52; H04N 1/4058; G06K 15/027; G06K 15/1807; G06K 15/1809

(57) ABSTRACT

In an example, a method includes determining, using a processor, a set of halftone screens each comprising tiles spanning a plurality of cells, wherein at least one screen is a non-orthogonal screen and the cells comprise parallelograms being defined by a first vector having a first length and second vector having a second length. A first and a second fundamental frequency may be determined for each of the screens using a projection of the first and of the second vector into each axis of a print apparatus reference frame, the first length and the second length. Using the first and second fundamental frequencies, it may be determined which screens are associated with moiré effects below a threshold.

### BACKGROUND

Printing systems may convert input data (for example, data representing an image for two-dimensional printing, or data representing an object for three dimensional printing) to print instructions, which specify where print materials (for example, colorants such as inks or toners or other printable materials) are to be placed in a print operation.

Techniques used in converting data include use of halftone screens. An example of a halftone screen is an amplitude modulation halftone screen, in which the locations in which a print material may be placed is predetermined, but the amount of a particular print material placed in that location depends on the input data. For example, depending on the amount of yellow associated with a particular print addressable region in an image, an amount of yellow print agent applied to the location may be high, low or zero.

### BRIEF DESCRIPTION OF DRAWINGS

For a more complete understanding, reference is now made to the following description taken in conjunction with the accompanying drawings in which:

FIG. 1 shows how a halftone screen may be constructed in an example;

FIG. 2 is a flowchart of an example method for determining which of a plurality of halftone screens may be affected by moiré effects;

FIG. 3 shows how a halftone cell may be constructed in an example;

FIG. 4 shows how a halftone tile may relate to halftone cells in an example;

FIG. 5 is a flowchart of an example method for generating a printed output;

FIG. 6 is an example processing circuitry; and

FIG. 7 is a simplified schematic of an example non-transitory machine readable medium associated with a processor.

### DETAILED DESCRIPTION

In the case of two-dimensional printing, a print addressable location may comprise at least one pixel, and each print addressable location may be printed with at least one colorant such as inks (for example cyan, magenta, yellow and black inks), coatings or other print materials, as well as combinations of those print materials.

In the case of three-dimensional printing, which is also referred to as additive manufacturing, three-dimensional space may be characterised in terms of ‘voxels’, i.e. three-dimensional pixels, wherein each voxel occupies or represents a discrete volume. In examples of three-dimensional printing therefore, an addressable area may comprise at least one voxel and each voxel may be ‘printed’ i.e. generated or manufactured, using one or a combination of agents and/or build materials.

To briefly discuss three-dimensional printing in greater detail, objects generated by an additive manufacturing process may be formed in a layer-by-layer manner. In one example, an object is generated by solidifying portions of layers of build material. In examples, the build material may be in the form of a powder or powder-like material, a fluid or a sheet material. In some examples, the intended solidification and/or physical properties may be achieved by printing an agent onto a layer of the build material. Energy may be applied to the layer and the build material on which an agent has been applied may coalesce and solidify upon cooling. In other examples, directed energy may be used to selectively cause coalescence of build material, or chemical binding agents may be used to solidify a build material. In other examples, three-dimensional objects may be generated by using extruded plastics or sprayed materials as build materials, which solidify to form an object. Some processes that generate three-dimensional objects use control data or print instructions generated from a model of a three-dimensional object. This control data may, for example, specify the locations at which to apply an agent to the build material, or where a build material itself may be placed, and the amounts to be placed. The control data may be generated from a 3D representation of an object to be printed. Locations may be expressed in terms of voxels. A voxel at a given location may have at least one characteristic. For example, it may be empty, may have a particular color or may represent a particular material, or a particular object property, or the like. In general, the voxels of an object may each have the same shape (for example, cubic or tetrahedral), or may differ in shape and/or size. However, where the term voxel is used herein to refer to a print addressable location, the voxel size may be determined at the print resolution of a print apparatus, i.e. it may correspond to a volume which can be individually addressed by a print apparatus (which may be a particular print apparatus, of a class of print apparatus, or the like) such that the properties thereof can be determined independently of the properties of other voxels.

In some examples of printing methods, patterns may be inadvertently formed in a printed output. For example, a ‘moiré’ pattern may be seen where clusters of dots repeat or, in the case of printing multiple colors (which may be printed in separate layers, or ‘separations’), dots from one color may visually interfere with dots printed in another color. Such patterns can detract from image quality. Well defined halftone screens can be used to avoid such patterns appearing in printed outputs, or to minimise their occurrence or impact.

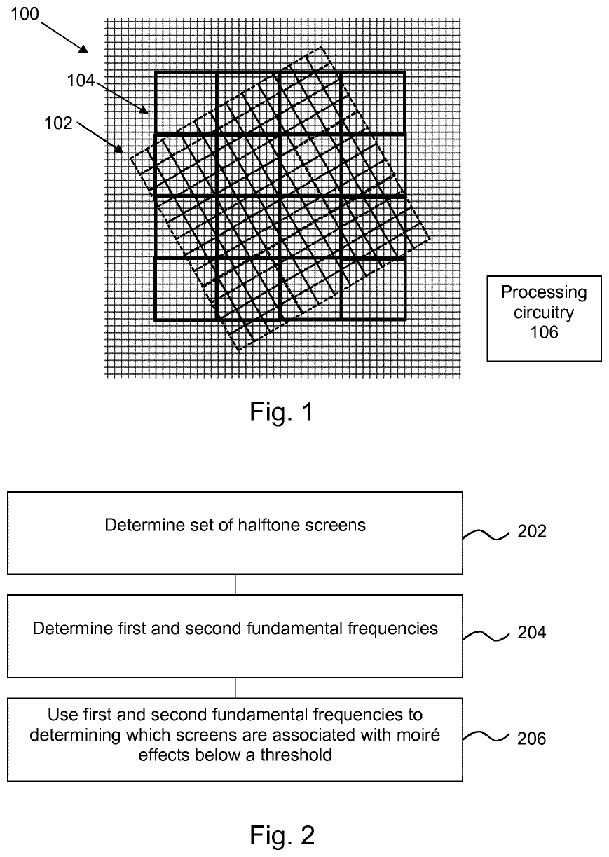

In order to explain the processing which may be applied to halftone screens according to examples set out herein, an illustration of the features and structures underlying an example halftone screen are described in relation to FIG. 1 in conjunction with processing circuitry 106.

FIG. 1 shows a pixel grid 100 (which may also be referred a laser grid). This represents a resolution of a print apparatus (and as such may depend on the print apparatus). Within this grid 100, a plurality of cells 102 are defined. Each cell covers a plurality of pixels. When printing a printed output, the number of pixels of each cell which may be ‘populated’ with dots may depend on the greyscale level of an associated print agent at that cell. Thus, if a cell 102 corresponds to a portion of the image/object which is black, the majority or all of the pixels may be populated with dots indicating the intended placement of a black print agent. However, if a cell 102 corresponds to a portion of the image/object which is grey, a proportion of pixels may be printed with black dots while a proportion are left unpopulated. Printing dispersed black dots on a white substrate produces an impression of a grey color to an observer at a distance.

While the examples of black and grey have been used here, the term ‘greyscale’ may be applied to any color, for example, each of a yellow, magenta, cyan and black print material set, or some other print material set, and indeed to other properties such as strength, resilience, conductivity and the like (although it may be noted that moiré is usually a visual effect).

Also overlying the grid 100 are a plurality of tiles 104. The tiles 104 are orthogonal and aligned with the pixel grid 100. In amplitude modulation, a greyscale level may be defined at the level of a tile, and therefore, for a given greyscale level, tiles 104 will be repeated (although a particular cell in a tile for a particular greyscale level may have a different number of populated pixels than another cell). An amplitude modulation screen may be made up of a plurality of repeated, or replicated tiles (i.e. tiles which will result in the same output for a given greyscale level, or expressed another way, tiles which using the same screening procedure to determine where to place print agent). Using replicated tiles reduces computational time in processing data for printing.

Screens which are likely to result in moiré effect (independently and/or in combination when a plurality of separations are printed) may be identified by applying tests thereto to identify underlying frequencies, or periodicities, in the screens.

As different screens may be used to provide different image effects, having access to a large number of at least substantially moiré free screens means that a screen or screen set suitable to a particular print job may be selected for printing.

As is shown in FIG. 1, cells 102 may be offset from a pixel grid 100 by an angle (and screens for different separations may be offset by different amounts). This allows multiple separations to be printed with less risk that a small misalignment will result in moiré effects. The cells 102 shown in FIG. 1 are orthogonal, i.e. have internal angles of 90°. While non-orthogonal screens may be used in some examples, using orthogonal screens eases the computational task of generating possible screens. However this also means that the number of available screen sets is relatively small compared to the whole solution space available if non-orthogonal tiles were also considered. Moreover, the use of replicated tiles 104 aligned with the grid 100 means that the offset angles which may be used for the screens are those which have rational tangents, which means that not all geometrical options for screen angles are available. In addition, it may be noted that the cells 102 have sides of equal length (which assumes that the addressability of the print apparatus is the same in two orthogonal directions), and the same number of halftone lines per unit length (which may be expressed as ‘Lines Per Inch’, or LPI). A ‘line’ in this context comprises a linear array of halftone cells, each of which may comprise a number of print material dots. Therefore, LPI is a measure of how close together the lines in a halftone grid are. In the cells 102, the LPI is the same in both directions (i.e. the cells 102 are square). Again, this assumption simplifies processing but reduces screen options.

The screen may be generated by and/or supplied to processing circuitry 106, which carries out a method as described in at least one block of FIG. 2.

FIG. 2 is an example of a method, which may be a computer implemented method, and/or a method of determining or identifying halftone screens which are suitable for at least substantially moiré free printing. In examples, the blocks of FIG. 2 may be carried out by at least one processor.

Block 202 comprises determining a set of halftone screens which may comprise amplitude modulation (AM) halftone screens. Each screen comprises tiles (which may be replicated tiles) comprising cells. The cells comprise parallelograms being defined by a first vector having a first length and second vector having a second length. At least one screen is a non-orthogonal screen (i.e. is made up of halftone cells which are non-orthogonal). The cells may for example span a plurality of print addressable pixels. Where the screen is an amplitude modulation halftone screen, the number of pixels in a cell which are associated with a print instruction may be determined based on the greyscale level in a region of an image corresponding to the cell. The screens may comprise at least one orthogonal screen (such as the screen shown in FIG. 1).

In some examples, each screen comprises tiles having a first and a second side length, where the first and the second side lengths span a natural number of both the first and the second lengths of the cells of that screen. This may assist in reducing the computational burden associated with the processing described below. In some examples, the first and second lengths may be natural numbers, which may again reduce the computational burden. In other examples, they may be floating point numbers.

Block 204 comprises determining, for each of the screens, first and second fundamental frequencies using a projection of the first and of the second vector into each axis of a print apparatus reference frame, the first length and the second length. The fundamental frequencies correspond to the largest periodicities in a screen. In some examples, the first and second fundamental frequencies may be determined in orthogonal directions, for example corresponding to the frequency along the length of a printed page and across the width of the printed page. The first length and the second length may be natural numbers, i.e. non-negative integers.

Block 206 comprises, using the first and second fundamental frequencies, determining which screens are associated with moiré effects below a threshold. Block 206 may be carried out in relation to each screen individually, and may in some examples comprise applying a first filter to identify screens which are likely to result in moiré effects alone, with a second filter being applied to identify screen combination (e.g. combination of screens for a plurality of print separations) which are likely to result in moiré effects.

By determining the projections of the first vector and of the second vector into each axis of a print apparatus reference frame (for example, this may be across the page and along the length of a page, and/or the axes of a pixel or laser grid), and the first length and the second length, the first and second fundamental frequencies may be derived in a generalised manner, which does not place any constraints on the underlying geometry (i.e. it extends to non-orthogonal cells). This method therefore allows the ‘solution space’ to be explored without such constraints, which may result in a greater range of solutions being derived. As noted above, depending on the use of a printed article, one screen or set of screens may be preferred over another. As is further noted below, in some examples, the projections may be multiplied by factors to provide natural numbers, i.e. non negative integers, which eases the computational burden in determining the fundamental frequencies. In some examples, the fundamental frequencies may be obtained using just natural numbers (i.e. no non-natural numbers). In some examples, six natural numbers characterising the halftone screen and being based on the first and second length and the projections may be used to determine the fundamental frequencies.

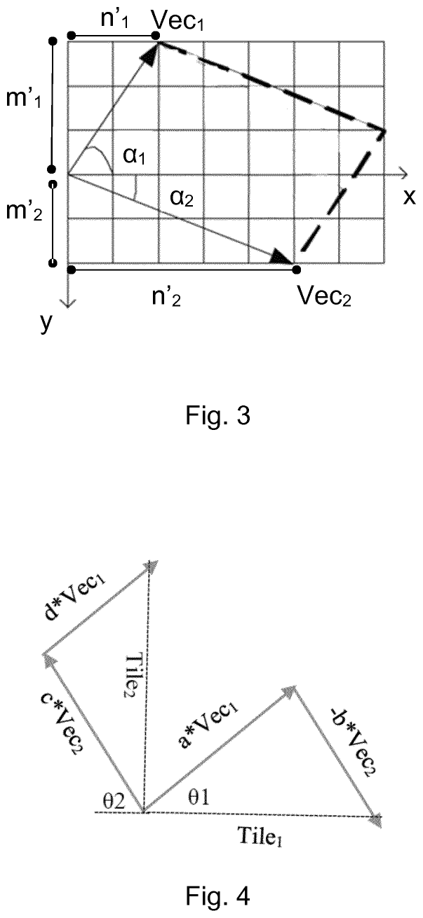

FIG. 3 shows an example of vectors which may be used to define the basis of a cell grid. As can be seen, two basis vectors, a first vector Vec₁ and a second vector Vec₂ (which extend at an angle the underlying grid, which represents the directionality of the laser grid). Considering the x and y directions, Vec₁ is at an angle of α₁ to the x direction and Vec₂ is at an angle of α₂ to the x direction. It may be noted that, in the example of the figure, α₁ and α₂ do not sum to 90°, i.e. the first and second vectors in this case define a non-orthogonal cell grid (and in turn a non-orthogonal screen). The vectors may be defined as the vectors to move from one cluster of dots (where the cluster could contain no, one or a plurality of dots depending on the intended print output) to the next cluster of dots.

It may be noted that the first and second vectors Vec₁, Vec₂ have different lengths. This reflects the fact that the addressability of a print apparatus may different in different direction. In some examples, a ‘dots per inch’ (dpi) addressability (which specifies how many dots can be printed within a line) and/or a ‘lines per inch’ (LPI) addressability may differ. However, the methods described herein may also be employed with orthogonal cell grids and/or examples in which the addressability which is the same in both directions. In some examples, the vectors have a magnitude associated with the relationship between the dpi and the LPI.

For example, the magnitudes may be expressed as:

$$‖ {Vec}_{1} ‖ = {Cellsize}_{1} = \frac{min ( {dpi}_{x} , {dpi}_{y} )}{{LPI}_{1}}$$

$$‖ {Vec}_{2} ‖ = {Cellsize}_{2} = \frac{min ( {dpi}_{x} , {dpi}_{y} )}{{LPI}_{2}}$$

As noted above in relation to block 204, the first and second fundamental frequencies may be determined using a projection of the first and of the second vector into each axis of a print apparatus reference frame. This projection may result in four values: n′₁, m′₁ (which are the projections of vec₁ into the x and y axis of the underlying pixel grid), n′₂, m′₂ (which are the projections of vec₂ into the x and y axis of the underlying pixel grid).

Expressed another way, Vec₁ may be defined as extending for n′₁ pixels in a first direction and m′₁ pixels in a second direction. Vec₂ may be defined as spanning n′₂ pixels in the first direction and m′₂ pixels in the second direction.

This may be expressed as:

Vec₁=[n′₁,m′₁],Vec₂=[n′₂,m′₂]

In some examples, it may be more convenient and computationally efficient to work in natural numbers. Therefore, determining the first and second fundamental frequencies may comprises multiplying each projection of the first vector by a first factor to provide a first integer n₁ and a second integer m₁ and multiplying each projection of the second vector by a second factor to provide a third integer n₂ and a fourth integer m₂. In such examples, determining the first fundamental frequency comprises using the first integer n₁ and the second integer m₁ and determining the second fundamental frequency comprises using third integer n₂ and the fourth integer m₂.

This may be expressed as:

$${Vec}_{1} = \frac{[ {n}_{1} , {m}_{1} ]}{{factor}_{1}} , {Vec}_{1} = \frac{[ {n}_{2} , {m}_{2} ]}{{factor}_{2}} ,$$

Where n₁, m₁, n₂, m₂, factor₁, factor₂ are positive integers.

In some examples, determining the first fundamental frequency comprises using the first length and the projections of the first vector into the axes of the print apparatus reference frame and determining the second fundamental frequency comprises using the second length and the projections of the second vector into the axes of a print apparatus reference frame. In each case, the projections may be multiplied by a factor so as to be natural numbers.

For example (and as will be set out in greater detail below), the fundamental frequencies may be expressed as

$${\vec{f}}_{1} = \frac{{n}_{1} \cdot \hat{x}}{{cellSize}_{1} \sqrt{{n}_{1}^{2} + {m}_{1}^{2}}} + \frac{{m}_{1} \cdot \hat{y}}{{cellSize}_{1} \sqrt{{n}_{1}^{2} + {m}_{1}^{2}}}$$

$${\vec{f}}_{2} = \frac{- {n}_{2} \cdot \hat{x}}{{cellSize}_{2} \sqrt{{n}_{2}^{2} + {m}_{2}^{2}}} + \frac{{m}_{2} \cdot \hat{y}}{{cellSize}_{2} \sqrt{{n}_{2}^{2} + {m}_{2}^{2}}}$$

Where \vec{f}₁ is the first fundamental frequency, \vec{f}₂ is the second fundamental frequency, cellSize₁ is the first length and cellSize₂ is the second length.

Thus is can be seen that, by defining a relatively small number of variables, the first and second fundamental frequencies may be readily determined. As the method for determining the first and second fundamental frequencies, a given processing resource may explore a solution space more efficiently (e.g. faster) than a more complex operation.

In other examples, the first and second lengths may be used to determine the fundamental frequencies by first being used to determine the size of the tiles. FIG. 4 shows how the first and second lengths may be used in determining tile size and thereby determine the first and second frequencies (i.e. the first and second frequencies may be determined using the first and second lengths indirectly). A first tile side length Tile₁ may be determined using the first length and a first cell count a in the direction of the first vector, and a second cell count b in the direction of the second vector. A second tile side length Tile₂ may be determined using the first length and a third cell count c in the direction of the first vector, and a fourth cell count d in the direction of the second vector. The cell count is effectively the number of cells spanned by a particular tile. As noted above, the screens may comprise tiles having a first and a second side length, where the first and the second side lengths span a natural number of both the first and the second lengths of the cells of that screen.

Using these vectors, a tile may be defined in terms of the cells it spans (in the direction of the fundamental vectors vec₁ and vec₂), which in this example is a natural number. As the tiles may be at an angle to the cells, the tiles may cut across the cell grid. This allows the fundamental frequencies may be expressed as:

$${\vec{f}}_{1} = \frac{( {m}_{2} {n}_{1} + {m}_{1} {n}_{2} ) \cdot {n}_{1} \cdot \hat{x}}{{Tile}_{1} \cdot ( {n}_{1}^{2} + {m}_{1}^{2} )} + \frac{( {m}_{2} {n}_{1} + {m}_{1} {n}_{2} ) \cdot {m}_{1} \cdot \hat{y}}{{Tile}_{1} \cdot ( {n}_{1}^{2} + {m}_{1}^{2} )} , \\ {\vec{f}}_{2} = - \frac{( {m}_{2} {n}_{1} + {m}_{1} {n}_{2} ) \cdot {n}_{2} \cdot \hat{x}}{{Tile}_{2} \cdot ( {n}_{2}^{2} + {m}_{1}^{2} )} + \frac{( {m}_{2} {n}_{1} + {m}_{1} {n}_{2} ) \cdot {m}_{2} \cdot \hat{y}}{{Tile}_{2} \cdot ( {n}_{2}^{2} + {m}_{2}^{2} )}$$

Here, six natural numbers may be used to find both fundamental frequencies.

In some examples, determining which screens are associated with moiré effects below a threshold in block 206 comprises determining an indication of an interference pattern for a screen used for a print apparatus having a predetermined pixel size, wherein determining the interference pattern comprises evaluating:

\vec{f}_{interference}=α₁\vec{f}₁+α₂\vec{f}₂+β₁\vec{g}₁+β₂\vec{g}₂

where \vec{f}₁ and \vec{f}₂ are the first and second fundamental frequencies, and

$${\vec{g}}_{1} = ( \frac{1}{pixelSize} ) \hat{x} and {\vec{g}}_{2} = ( \frac{1}{pixelSize} ) \hat{y}$$

(where pixelSize is a measure of the separation between the centres of the pixels).

α₁, α₁, β₁ and β₂ are integers. The Fourier Transform of a grid is also a grid (with reciprocal length of its basis vectors). The fundamental frequency may be termed the first harmony, with higher frequencies called higher harmonies. α₁, α₁, β₁ and β₂ denotes the frequency harmony, and the sum of α₁, α₁, β₁ and β₂ is called the ‘moiré order’.

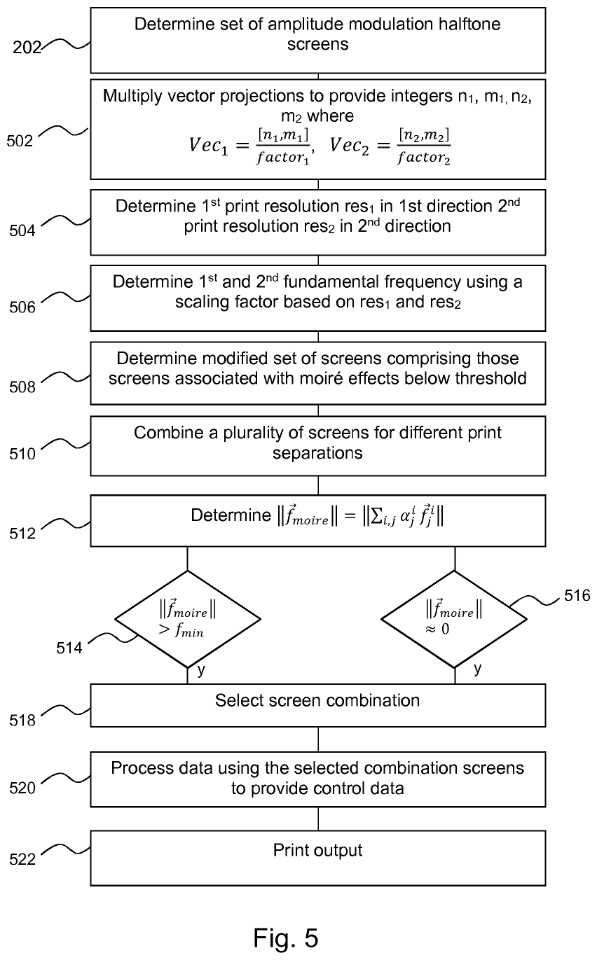

FIG. 5 is another example of a method for determining a set of screens. In this example, the method starts with block 202 as described above. In this example, each screen comprises tiles having a first and a second side length, where the first and the second side lengths span a natural number of the both the first and the second lengths of the cells of that screen.

Block 502 comprises multiplying each projection of the first vector by a first factor to provide a first natural number n₁ and a second natural number m₁ and multiplying each projection of the second vector by a second factor to provide a third natural number n₂ and a fourth natural number m₂, for example as described above.

Block 504 comprises determining a first print resolution res₁ in a first direction and a second print resolution res₂ in a second direction, orthogonal to the first direction.

Block 506 comprises determining a first and a second fundamental frequency using a scaling factor based on the first and second print resolutions. For example, the first and second fundamental frequency may be expressed using scaling factors r₁ and r₂ as:

$${\vec{f}}_{1} = \frac{{n}_{1} \cdot \hat{x}}{{cellSize}_{1} \sqrt{{r}_{1} \cdot {n}_{1}^{2} + {r}_{2} \cdot {m}_{1}^{2}}} + \frac{{m}_{1} \cdot \hat{y}}{{cellSize}_{1} \sqrt{{r}_{1} \cdot {n}_{1}^{2} + {r}_{2} \cdot {m}_{1}^{2}}}$$

$${\vec{f}}_{2} = \frac{- {n}_{2} \cdot \hat{x}}{{cellSize}_{2} \sqrt{{r}_{1} \cdot {n}_{2}^{2} + {r}_{2} \cdot {m}_{2}^{2}}} + \frac{{m}_{2} \cdot \hat{y}}{{cellSize}_{2} \sqrt{{r}_{1} \cdot {n}_{2}^{2} + {r}_{2} \cdot {m}_{2}^{2}}}$$

where \hat{x} and ŷ are unit vectors, and for res₁≥res₂, r₁=(res₂/res₁)² and r₂=1 and for res₁<res₂, r₁=1 and r₂=(res₁/res₂)². A similar relationship may be derived based on tile size.

Block 508 comprises determining a modified set of screens comprising those screens associated with moiré effects below a threshold, which may be a predetermined threshold. For example, \vec{f}_{interference} may be compared to a threshold, and screens which are above the threshold are retained (as interference becomes less perceptible above a threshold). This identifies periodic patterns which may occur in individual screens as a result of interference between the cell grid and the pixel grid, which may therefore be filtered out of a screen set before the method continues.

Block 510 comprises, for the modified set of screens, combining a plurality of screens corresponding to different print separations.

Block 512 comprises determining, for the combination,

∥\vec{f}ₘₒᵢᵣₑ∥=∥Σ_{i,j}αⱼⁱ\vec{f}ⱼⁱ∥

wherein f is a fundamental frequency, i and j are non-negative integers, 1≤i≤number of separations and j=(1,2), and Σαⱼⁱ denotes a moiré order.

Block 514 comprises determining if ∥\vec{f}ₘₒᵢᵣₑ∥>fₘᵢₙ

For examples, fₘᵢₙ may be set to be the maximal frequency for moiré which is detected by a human eye at a viewing distance of around 30 cm for the lowest order moiré effects (which is around 85 LPI). Higher ordered moiré vectors may also be considered, for example using a lower band (for example around 70 LPI for moiré order 3, and lower for higher orders) as their visibility drops with increasing order number. Different applications may result in different thresholds being applied (for example, a viewing distance of a poster may be higher than a printed page in a book, so a different threshold may be appropriate, and/or moiré may be tolerated more in some use cases than in others).

This detects high frequency moiré. Effectively, it allows the identification of screen combinations in which the frequency is too high and the moiré effect is too low to be observed, and which may therefore be acceptable for use in printing.

Block 516 comprises determining if ∥\vec{f}ₘₒᵢᵣₑ∥≈0

This allows identification of screen sets having almost 0 moiré. The range of values which are determined to be approximately equal to zero may again depend on factors such as the use case, such as intended viewing distance, the extent to which moiré may be tolerated, and the like.

In other words, screen combinations which are associated with moiré frequencies in a band which is above a low threshold but below a high threshold associated with the limits of human observation may be identified by such a method, as they do not pass the tests set by blocks 514 and 516. Such screen combinations may be rejected as they will result in an observable moiré effect (or, expressed another way, a moiré effect above a threshold) if used to produce a printed output.

Block 518 comprises selecting at least one combination of screens for which at least one of the conditions of block 514 and block 516 is satisfied and block 520 comprises processing input data using the selected set of screens to provide control data for a print output and block 522 comprises printing the print output. This will produce a print output which is unlikely to exhibit moiré patterns.

A print apparatus may print an article according to print instructions/control data, and to that end may comprise print apparatus components such as print head(s), at least one print agent supplies, and the like. Where the print apparatus is a ‘two dimensional’ printer, it may for example comprise a laser printer or an inkjet printer or the like, and may comprise a print head, substrate handling systems, sources of inks or toner, and the like. Where the printer is a ‘three dimensional’ printer, it may comprise, or be associated with, a print bed, a fabrication chamber, a print head, at least one energy source, a source of build material, or the like.

A further discussion of the analytical basis for methods describes herein follows, which refers again to the example of a non-orthogonal halftone screen which was described above with reference to FIG. 4:

FIG. 4 shows an example of a tile having sides Tile₁ and Tile₂ defined by vectors. For the sake of the following computations, the magnitude of each vector corresponds to the length of a side of a cell, i.e.

$$‖ {Vec}_{1} ‖ = {CellSize}_{1} = \frac{min ( {dpi}_{x} , {dpi}_{y} )}{{LPI}_{1}}$$

$$‖ {Vec}_{2} ‖ = {CellSize}_{2} = \frac{min ( {dpi}_{x} , {dpi}_{y} )}{{LPI}_{2}}$$

Where CellSize1 and CellSize2 are first and second side lengths of a cell (noting that a cell is a parallelogram with two pairs of sides), dpi is ‘dots per inch’ and LPI is lines per inch, in an x and y respective direction.

It may be noted that 0°<θ₁<90°, 0°<θ₂<90°. In addition, max (dpiₓ, dpi_{y})/min(dpiₓ, dpi_{y}) may be a non-negative integer.

As can be seen from the Figure,

a·Vec₁^{y}−b·Vec₂^{y}=0

a·Vec₁^{x}+b·Vec₂^{x}=Tile₁

c·Vec₂^{x}+d·Vec₁^{x}=0

c·Vec₂^{y}+d·Vec₁^{y}=Tile₂

Where: Tile₁ is first side length of a tile, Tile₂=second side length of a tile, a is a cell count of first side of tile in Vec₁ direction, d is a cell count of second side of tile in Vec₁ direction, b is a cell count of first side of tile in Vec₂ direction and c is a cell count of second side of tile in Vec₂ direction. a, b, c and d are non-negative integers (i.e. may be zero or a positive integer) and Tile₁ and Tile₂ are positive integers.

It may be noted that:

$$tan {θ}_{1} = \frac{{m}_{1}^{′}}{{n}_{1}^{′}} \cdot ( \frac{{dpi}_{x}}{{dpi}_{y}} ) = \frac{{m}_{1}}{{n}_{1}} \cdot ( \frac{{dpi}_{x}}{{dpi}_{y}} ) , and$$

$$tan {θ}_{2} = \frac{{m}_{2}^{′}}{{n}_{2}^{′}} \cdot ( \frac{{dpi}_{x}}{{dpi}_{y}} ) = \frac{{m}_{2}}{{n}_{2}} \cdot ( \frac{{dpi}_{x}}{{dpi}_{y}} )$$

On this basis, it can be seen that:

$$a \cdot ( \frac{{m}_{1}}{{factor}_{1}} ) - b \cdot ( \frac{{m}_{2}}{{factor}_{2}} ) = 0 \\ - c \cdot ( \frac{{n}_{2}}{{factor}_{2}} ) + d \cdot ( \frac{{n}_{1}}{{factor}_{1}} ) = 0$$

$$a \cdot ( \frac{{n}_{1}}{{factor}_{1}} ) + b \cdot ( \frac{{n}_{2}}{{factor}_{2}} ) = {Tile}_{1}$$

$$c \cdot ( \frac{{m}_{2}}{{factor}_{2}} ) + d \cdot ( \frac{{m}_{1}}{{factor}_{1}} ) = {Tile}_{2}$$

$$And \text{:}$$

$$b = a \cdot ( \frac{{m}_{1}}{{m}_{2}} ) \cdot ( \frac{{factor}_{2}}{{factor}_{1}} ) , \\ d = c \cdot ( \frac{{n}_{2}}{{n}_{1}} ) \cdot ( \frac{{factor}_{1}}{{factor}_{2}} )$$

$$And \text{:}$$

$${Tile}_{1} = a \cdot \frac{{n}_{1}}{{factor}_{1}} + a \cdot ( \frac{{m}_{1}}{{m}_{2}} ) \cdot ( \frac{{factor}_{2}}{{factor}_{1}} ) \cdot \frac{{n}_{2}}{{factor}_{2}}$$

$${Tile}_{2} = c \cdot \frac{{m}_{2}}{{factor}_{2}} + c \cdot ( \frac{{n}_{2}}{{n}_{1}} ) \cdot ( \frac{{factor}_{1}}{{factor}_{2}} ) \cdot \frac{{m}_{1}}{{factor}_{1}}$$

If it is assumed without loss of generality that a=m₂ and c=n₁ (which assumption may be made to simplify the equations: a, b, c and d may still be non-negative integers: it may be noted that while in principle any non-negative integers may be selected for a and c, b and d are function of a and c and cannot be selected arbitrarily) then:

$$b = {m}_{1} \cdot ( \frac{{factor}_{2}}{{factor}_{1}} )$$

$$d = {n}_{2} \cdot ( \frac{{factor}_{1}}{{factor}_{2}} )$$

$${Tile}_{1} = {m}_{2} \cdot \frac{{n}_{1}}{{factor}_{1}} + {m}_{1} \cdot \frac{{n}_{2}}{{factor}_{2}}$$

$${Tile}_{2} = {n}_{1} \cdot \frac{{m}_{2}}{{factor}_{2}} + {n}_{2} \cdot \frac{{m}_{1}}{{factor}_{2}}$$

From which it may be derived that:

$${factor}_{1} = \frac{{n}_{1} {m}_{2} + {n}_{2} {m}_{1}}{{Tile}_{1}}$$

$${factor}_{2} = \frac{{n}_{1} {m}_{2} + {n}_{2} {m}_{1}}{{Tile}_{2}}$$

$$b = {m}_{1} \cdot ( \frac{{Tile}_{1}}{{Tile}_{2}} )$$

$$d = {n}_{2} \cdot ( \frac{{Tile}_{2}}{{Tile}_{1}} )$$

To verify that factor₁, factor₂, b and d are natural numbers (i.e. non-negative integers), each input term may be multiplied by their least common divider (lcm):

lcmTile=lcm(Tile₁,Tile₂)

| | | |
|---|---|---|
| m₁ = m₁ · lcmTile | n₁ = n₁ · lcmTile | Tile₁ = Tile₁ · lcmTile |
| m₂ = m₂ · lcmTile | n₂ = n₂ · lcmTile | Tile₂ = Tile₂ · lcmTile |

a, b, c and d may be recalculated using the same formula as above.

Cellsize (or LPI) and angle of each vector may be calculated as follow:

$$‖ {Vec}_{1} ‖ = {CellSize}_{1} = \frac{{dpi}_{y}}{{LPI}_{1}} = {dpi}_{y} \sqrt{\frac{{{n}_{1}^{′}}^{2}}{{dpi}_{x}^{2}} + \frac{{{m}_{1}^{′}}^{2}}{{dpi}_{y}^{2}}} = \frac{{dpi}_{y} \sqrt{{n}_{1}^{2} \cdot {( \frac{{dpi}_{y}}{{dpi}_{x}} )}^{2} + {m}_{1}^{2}}}{{dpi}_{y} \cdot {factor}_{1}} = {Tile}_{1} \cdot \frac{\sqrt{{n}_{1}^{2} \cdot {( \frac{{dpi}_{y}}{{dpi}_{x}} )}^{2} + {m}_{1}^{2}}}{( {m}_{2} {n}_{1} + {m}_{1} {n}_{2} )} if \frac{{dpi}_{x}}{{dpi}_{y}} \geq 1 \\ ‖ {Vec}_{2} ‖ = {CellSize}_{2} = \frac{{dpi}_{y}}{{LPI}_{2}} = {dpi}_{x} \sqrt{\frac{{{n}_{2}^{′}}^{2}}{{dpi}_{x}^{2}} + \frac{{{m}_{2}^{′}}^{2}}{{dpi}_{Y}^{2}}} = \frac{{dpi}_{x} \sqrt{{n}_{2}^{2} \cdot {( \frac{{dpi}_{y}}{{dpi}_{x}} )}^{2} + {m}_{2}^{2}}}{{dpi}_{y} \cdot {factor}_{2}} = {Tile}_{2} \cdot \frac{{dpi}_{x} \sqrt{{n}_{2}^{2} \cdot {( \frac{{dpi}_{y}}{{dpi}_{x}} )}^{2} + {m}_{2}^{2}}}{{dpi}_{y} \cdot ( {m}_{2} {n}_{1} + {m}_{1} {n}_{2} )} if \frac{{dpi}_{x}}{{dpi}_{y}} \geq 1$$

$$‖ {Vec}_{1} ‖ = {CellSize}_{1} = \frac{{dpi}_{x}}{{LPI}_{1}} = {dpi}_{y} \sqrt{\frac{{{n}_{1}^{′}}^{2}}{{dpi}_{x}^{2}} + \frac{{{m}_{1}^{′}}^{2}}{{dpi}_{Y}^{2}}} = \frac{{dpi}_{y} \cdot \sqrt{{n}_{1}^{2} + {m}_{1}^{2} \cdot {( \frac{{dpi}_{x}}{{dpi}_{y}} )}^{2}}}{{dpi}_{x} \cdot {factor}_{1}} = {Tile}_{1} \cdot \frac{{dpi}_{y} \sqrt{{n}_{1}^{2} + {m}_{1}^{2} \cdot {( \frac{{dpi}_{x}}{{dpi}_{y}} )}^{2}}}{{dpi}_{x} \cdot ( {m}_{2} {n}_{1} + {m}_{1} {n}_{2} )} if \frac{{dpi}_{x}}{{dpi}_{y}} < 1$$

$$‖ {Vec}_{2} ‖ = {CellSize}_{2} = \frac{{dpi}_{x}}{{LPI}_{2}} = {dpi}_{x} \sqrt{\frac{{{n}_{2}^{′}}^{2}}{{dpi}_{x}^{2}} + \frac{{{m}_{2}^{′}}^{2}}{{dpi}_{Y}^{2}}} = \frac{{dpi}_{x} \cdot \sqrt{{n}_{2}^{2} + {m}_{2}^{2} \cdot {( \frac{{dpi}_{x}}{{dpi}_{y}} )}^{2}}}{{dpi}_{x} \cdot {factor}_{2}} = {Tile}_{2} \cdot \frac{\sqrt{{n}_{2}^{2} + {m}_{2}^{2} \cdot {( \frac{{dpi}_{x}}{{dpi}_{y}} )}^{2}}}{( {m}_{2} {n}_{1} + {m}_{1} {n}_{2} )} if \frac{{dpi}_{x}}{{dpi}_{y}} < 1$$

$$And$$

$${θ}_{1} = {tan}^{- 1} ( \frac{{m}_{1} \cdot {dpi}_{x}}{{n}_{1} \cdot {dpi}_{y}} ) , {θ}_{2} = {tan}^{- 2} ( \frac{{m}_{2} \cdot {dpi}_{x}}{{n}_{2} \cdot {dpi}_{y}} ) ,$$

Finally, using Vec₁ and Vec₂, a cell grid may be created as follows:

$$CellGridVec = α {Vec}_{1} + β {Vec}_{2}$$

$$α , β ∈ Z , i . e . α and β are integers$$

$${CellGridVec}_{x} = mod ( {cellGridVec}_{x} , {Tile}_{1} )$$

$${CellGridVec}_{y} = mod ( {cellGridVec}_{x} , {Tile}_{2} )$$

$${Vec}_{1} = ( {cellSize}_{1} cos {θ}_{1} \cdot ( \frac{{dpi}_{x}}{{dpi}_{y}} ) , {cellSize}_{1} sin {θ}_{1} ) = \frac{{cellSize}_{1} \cdot {n}_{1} \cdot \hat{x}}{\sqrt{{n}_{1}^{2} \cdot ( \frac{{dpi}_{y}^{2}}{{dpi}_{x}^{2}} ) + {m}_{1}^{2}}} + \frac{{cellSize}_{1} \cdot {m}_{1} \cdot \hat{y}}{\sqrt{{n}_{1}^{2} \cdot ( \frac{{dpi}_{y}^{2}}{{dpi}_{x}^{2}} ) + {m}_{1}^{2}}} , if ( \frac{{dpi}_{x}}{{dpi}_{y}} ) \geq 1$$

$${Vec}_{2} = ( - {cellSize}_{2} cos {θ}_{2} \cdot ( \frac{{dpi}_{x}}{{dpi}_{y}} ) , {cellSize}_{2} sin {θ}_{2} ) = - \frac{{cellSize}_{2} \cdot {n}_{2} \cdot \hat{x}}{\sqrt{{n}_{2}^{2} \cdot ( \frac{{dpi}_{y}^{2}}{{dpi}_{x}^{2}} ) + {m}_{2}^{2}}} + \frac{{cellSize}_{2} \cdot {m}_{2} \cdot \hat{y}}{\sqrt{{n}_{2}^{2} \cdot ( \frac{{dpi}_{y}^{2}}{{dpi}_{x}^{2}} ) + {m}_{2}^{2}}} , if ( \frac{{dpi}_{x}}{{dpi}_{y}} ) \geq 1$$

$${Vec}_{1} = ( {cellSize}_{1} cos {θ}_{1} , {cellSize}_{1} sin {θ}_{1} \cdot ( \frac{{dpi}_{y}}{{dpi}_{x}} ) ) = \frac{{cellSize}_{1} \cdot {n}_{1} \cdot \hat{x}}{\sqrt{{n}_{1}^{2} + {m}_{1}^{2} \cdot ( \frac{{dpi}_{x}^{2}}{{dpi}_{y}^{2}} )}} + \frac{{cellSize}_{1} \cdot {m}_{1} \cdot \hat{y}}{\sqrt{{n}_{1}^{2} + {m}_{1}^{2} \cdot ( \frac{{dpi}_{x}^{2}}{{dpi}_{y}^{2}} )}} , if ( \frac{{dpi}_{x}}{{dpi}_{y}} ) < 1$$

$${Vec}_{2} = ( - {cellSize}_{1} cos {θ}_{2} , {cellSize}_{2} sin {θ}_{2} \cdot ( \frac{{dpi}_{y}}{{dpi}_{x}} ) ) = - \frac{{cellSize}_{2} \cdot {n}_{2} \cdot \hat{x}}{\sqrt{{n}_{2}^{2} + {m}_{2}^{2} \cdot ( \frac{{dpi}_{x}^{2}}{{dpi}_{y}^{2}} )}} + \frac{{cellSize}_{2} \cdot {m}_{2} \cdot \hat{y}}{\sqrt{{n}_{2}^{2} + {m}_{2}^{2} \cdot ( \frac{{dpi}_{x}^{2}}{{dpi}_{y}^{2}} )}} , if ( \frac{{dpi}_{x}}{{dpi}_{y}} ) < 1$$

In addition:

$$\begin{matrix} {Vec}_{1} = \frac{{Tile}_{1} \cdot {n}_{1} \cdot \hat{x}}{( {m}_{2} {n}_{1} + {m}_{1} {n}_{2} )} + \frac{{Tile}_{1} \cdot {m}_{1} \cdot \hat{y}}{( {m}_{2} {n}_{1} + {m}_{1} {n}_{2} )} , & if ( \frac{{dpi}_{x}}{{dpi}_{y}} ) \geq 1 \\ {Vec}_{2} = - ( \frac{{dpi}_{x}}{{dpi}_{y}} ) \cdot \frac{{Tile}_{2} \cdot {n}_{2} \cdot \hat{x}}{( {m}_{2} {n}_{1} + {m}_{1} {n}_{2} )} + ( \frac{{dpi}_{x}}{{dpi}_{y}} ) \cdot \frac{{Tile}_{2} \cdot {m}_{2} \cdot \hat{y}}{( {m}_{2} {n}_{1} + {m}_{1} {n}_{2} )} , & if ( \frac{{dpi}_{x}}{{dpi}_{y}} ) \geq 1 \\ {Vec}_{1} = ( \frac{{dpi}_{y}}{{dpi}_{x}} ) \cdot \frac{{Tile}_{1} \cdot {n}_{1} \cdot \hat{x}}{( {m}_{2} {n}_{1} + {m}_{1} {n}_{2} )} + ( \frac{{dpi}_{y}}{{dpi}_{x}} ) \cdot \frac{{Tile}_{1} \cdot {m}_{1} \cdot \hat{y}}{( {m}_{2} {n}_{1} + {m}_{1} {n}_{2} )} , & if ( \frac{{dpi}_{x}}{{dpi}_{y}} ) < 1 \\ {Vec}_{2} = \frac{{Tile}_{2} \cdot {n}_{2} \cdot \hat{x}}{( {m}_{2} {n}_{1} + {m}_{1} {n}_{2} )} + \frac{{Tile}_{2} \cdot {m}_{2} \cdot \hat{y}}{( {m}_{2} {n}_{1} + {m}_{1} {n}_{2} )} , & if ( \frac{{dpi}_{x}}{{dpi}_{y}} ) < 1\end{matrix}$$

In the special case of dpiₓ=dpi_{y}:

$${\vec{f}}_{1} = \frac{( {m}_{2} {n}_{1} + {m}_{1} {n}_{2} ) \cdot {n}_{1} \cdot \hat{x}}{{Tile}_{1} \cdot ( {n}_{1}^{2} + {m}_{1}^{2} )} + \frac{( {m}_{2} {n}_{1} + {m}_{1} {n}_{2} ) \cdot {m}_{1} \cdot \hat{y}}{{Tile}_{1} \cdot ( {n}_{1}^{2} + {m}_{1}^{2} )} , \\ {\vec{f}}_{2} = - \frac{( {m}_{2} {n}_{1} + {m}_{1} {n}_{2} ) \cdot {n}_{2} \cdot \hat{x}}{{Tile}_{2} \cdot ( {n}_{2}^{2} + {m}_{2}^{2} )} + \frac{( {m}_{2} {n}_{1} + {m}_{1} {n}_{2} ) \cdot {m}_{2} \cdot \hat{y}}{{Tile}_{2} \cdot ( {n}_{2}^{2} + {m}_{2}^{2} )}$$

In the special case of square orthogonal screen (with same dpi in horizontal and vertical directions):

$$\begin{matrix}{Tile}_{1} = {Tile}_{2} = Tile & {m}_{1} = m \\ {θ}_{1} = θ & {n}_{1} = n \\ {θ}_{2} = 90 - {θ}_{1} & {m}_{2} = {n}_{1} = n \\ {dpi}_{x} = {dpi}_{y} = dpi & {n}_{2} = {m}_{1} = m\end{matrix}$$

$$‖ {Vec}_{1} ‖ = {CellSize}_{1} = \frac{dpi}{{LPI}_{1}} = {Tile}_{1} \cdot \frac{\sqrt{{n}_{1}^{2} + {m}_{1}^{2}}}{{m}_{2} {n}_{1} + {m}_{1} {n}_{2}} = Tile \cdot \frac{\sqrt{{n}^{2} + {m}^{2}}}{{n}^{2} + {m}^{2}} = \frac{Tile}{\sqrt{{n}^{2} + {m}^{2}}}$$

$$‖ {Vec}_{2} ‖ = {CellSize}_{2} = \frac{dpi}{{LPI}_{2}} = {Tile}_{2} \cdot \frac{\sqrt{{n}_{2}^{2} + {m}_{2}^{2}}}{{m}_{2} {n}_{1} + {m}_{1} {n}_{2}} = Tile \cdot \frac{\sqrt{{m}^{2} + {n}^{2}}}{{n}^{2} + {m}^{2}} = \frac{Tile}{\sqrt{{n}^{2} + {m}^{2}}}$$

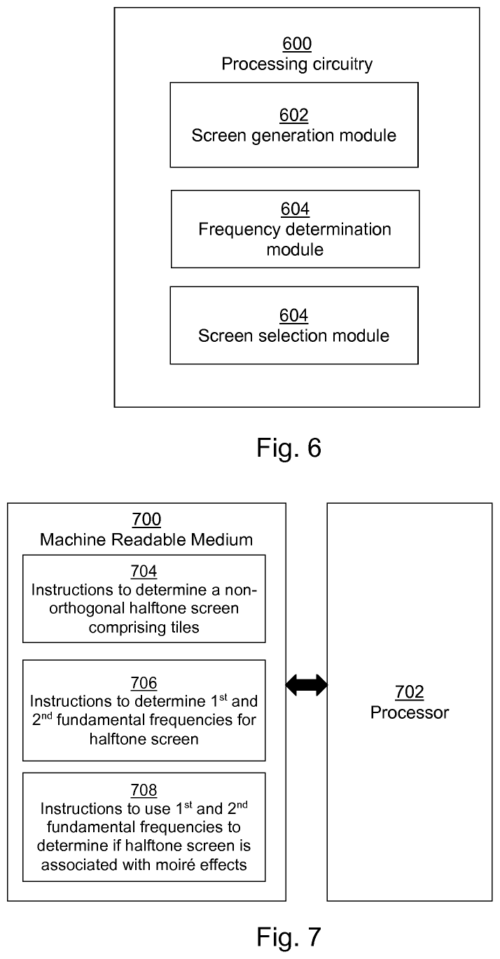

FIG. 6 is an example of processing circuitry 600 comprising a screen generation module 602, a frequency determination module 604 and a screen selection module 606. The processing circuitry 600 may be an example of processing circuitry 106.

The screen generation module 602 generates a plurality of halftone screens each comprising tiles comprising cells, the cells comprising parallelograms being defined by a first vector having a first length and second vector having a second length, wherein at least one screen comprises non-orthogonal cells. In some examples, the screen generation module 602 generates the plurality of halftone screens such that each screen comprises tiles having a first and a second side length, where the first and the second side length span a non-negative integer number of the first and the second lengths of the cells of that screen. In other words, a tile side length may be defined by projecting a non-negative integer number of the first vector and a non-negative integer number of the second vector into the tile reference frame (which as noted above may be aligned with the print apparatus reference frame).

The frequency determination module 604 determines for each of a plurality of screens, first and second orthogonal fundamental frequencies using a projection of the first and of the second vector defining the cells of that screen into each axis of a print apparatus reference frame, the first length and the second length, for example as described above in relation to block 206.

The screen selection module 606 tests each screen for moiré effect, for example as described above in relation to block 206. In some examples, in operation, the screen selection module 606 further retains screens which are associated with a moiré effect below a threshold and discard screens which are associated with a moiré effect above the threshold. For example, this may be as described in relation to block 508 above. In some examples, the screen selection module 606 is to combine a plurality of retained screens and to test the combinations of screens for moiré effect; and to discard combinations of screens which are associated with a moiré effect above a threshold. As moiré effects have a lower and an upper frequency limit for perceptibility, this may comprise discarding those screens or screen combination which are associated with a moiré frequency which is in a visible range, for example being greater than zero (or close to zero) but less than an upper frequency associated with the limits of perceptibility of moiré patterns. For example, this may be as described in block 510 to 518 above.

The processing circuitry 600 may carry out any, or any combination of the blocks of FIG. 2 and/or FIG. 5.

FIG. 7 shows an example of a non-transitory machine readable medium 700 in association with a processor 702. The machine readable medium 700 comprises instructions 704 which, when executed by the processor 702, cause the processor to determine a non-orthogonal halftone screen comprising tiles spanning a plurality of halftone cells having a print addressable area of variable size, the cells comprising non-orthogonal parallelograms being defined by a first vector having a first length and second vector having a second length. In some examples, the instructions 704 cause the processor 702 to determine a non-orthogonal halftone screen to comprise tiles having a first and a second side length, where the first and the second side length span a non-negative integer number of the first and the second lengths of the cells of that screen.

The machine readable medium 700 further comprises instructions 706 which, when executed by the processor 702, cause the processor 702 to determine first and second fundamental frequencies for the halftone screen using a projection of the first and of the second vector into each axis of a print apparatus reference frame, the first length and the second length; and

The machine readable medium 700 further comprises instructions 708 which, when executed by the processor 702, cause the processor 702 to use the first and second fundamental frequencies to determine if the halftone screen is associated with moiré effects.

In some examples, the machine readable medium 700 further comprises instructions which, when executed by the processor 702, cause the processor 702 to combine a plurality of screens and test the combinations of screens to determine if the screen is associated with moiré effects.

The machine readable medium 700 may comprise instructions which cause the processor to carry out any of the blocks of FIG. 2 or FIG. 5. The machine readable medium 700 may comprise instructions which cause the processor 702 to act as the processing circuitry 600 of FIG. 6.

The screen generation module 602, frequency determination module 604 and screen selection module 606 may be implemented with one or a plurality of processors executing machine readable instructions stored in a memory, or a processor operating in accordance with instructions embedded in logic circuitry. It is noted that in at least one example described herein, the term “module” refers to a hardware component of the apparatus.

Examples in the present disclosure can be provided as methods, systems or machine readable instructions, such as any combination of software, hardware, firmware or the like. Such machine readable instructions may be included on a non-transitory machine (for example, computer) readable storage medium (including but is not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus, or a module thereof, may execute the machine readable instructions. Thus functional modules of the processing circuitry 600 (for example, the screen generation module 602, frequency determination module 604 and screen selection module 606) and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
determining, using a processor, a set of halftone screens each comprising tiles spanning a plurality of cells, wherein at least one screen is a non-orthogonal screen and the cells comprise parallelograms being defined by a first vector having a first length and second vector having a second length;
determining, using a processor, for each of the screens, first and second fundamental frequencies using a projection of the first and of the second vector into each axis of a print apparatus reference frame, the first length and the second length; and
determining, using a processor and the first and second fundamental frequencies, which screens are associated with moiré effects below a threshold.

2. A method according to claim 1 wherein determining the first fundamental frequency comprises using the first length and the projections of the first vector into the axes of the print apparatus reference frame and determining the second fundamental frequency comprises using the second length and the projections of the second vector into the axes of a print apparatus reference frame.

3. A method according to claim 2 wherein determining which screens are associated with moiré effects below a threshold comprises determining an indication of an interference pattern for a screen used for a print apparatus having a predetermined pixel size, wherein determining the interference pattern comprises evaluating:
\vec{f}_{interference}=α₁\vec{f}₁+α₂\vec{f}₂+β₁\vec{g}₁+β₂\vec{g}₂
where \vec{f}₁ and \vec{f}₂ are the first and second fundamental frequencies, α₁, α₁, β₁ and β₂ are integers
$$and {\vec{g}}_{1} = ( \frac{1}{pixelSize} ) \hat{x} and {\vec{g}}_{2} = ( \frac{1}{pixelSize} ) \hat{y} .$$

4. A method according to claim 1 wherein determining the first and second fundamental frequencies comprises multiplying each projection of the first vector by a first factor to provide a first non-negative integer n₁ and a second non-negative integer m₁ and multiplying each projection of the second vector by a second factor to provide a third non-negative integer n₂ and a fourth non-negative integer m₂, wherein determining the first and second fundamental frequencies comprises using the first, second, third and fourth non-negative integers n₁, m₁, n₂, m₂.

5. A method according to claim 1 wherein determining the first and second fundamental frequencies comprises determining a first tile side length and a second tile side length using the projections of the first and second vectors into the axes of the print apparatus reference frame and a cell count of first side of tile in the direction of the first vector, a cell count of second side of tile in the direction of the first vector, a cell count of first side of tile in the direction of the second vector and a cell count of second side of tile in the direction of the second vector, wherein each of the first, second third and fourth cell counts comprise non-negative integers.

6. A method according to claim 1 further comprising determining a first print resolution res₁ in a first direction and a second print resolution res₂ in a second direction, orthogonal to the first direction, wherein determining the first and second fundamental frequencies further comprises using a scaling factor based on the first and second print resolutions.

7. A method according to claim 1 further comprising determining a modified set of screens comprising those screens associated with moiré effects below a threshold.

8. A method according to claim 7 further comprising, for the modified set of screens, combining a plurality of screens corresponding to different print separations and determining for that combination:
$$‖ {\vec{f}}_{moire} ‖ = ‖ {\sum }_{i , j} {α}_{j}^{i} {\vec{f}}_{j}^{i} ‖$$
wherein f is a fundamental frequency, i and j are non-negative integers, 1≤i≤number of separations and j=(1,2), and Σαⱼⁱ denotes a moiré order.

9. A method according to claim 7 further comprising selecting a set of screens for a print output, the set of screens being selected such that ∥\vec{f}ₘₒᵢᵣₑ∥≈0 or >fₘᵢₙ, where fₘᵢₙ is a threshold relating to moiré detectability.

10. A method according to claim 9 further comprising processing input data using the selected set of screens to provide control data for a print output and printing the print output.

11. Processing circuitry comprising:
a screen generation module to generate a plurality of halftone screens each comprising tiles comprising cells, the cells comprising parallelograms being defined by a first vector having a first length and second vector having a second length, wherein at least one screen comprises non-orthogonal cells;
a frequency determination module to determine for each of a plurality of screens, first and second orthogonal fundamental frequencies using a projection of the first and of the second vector for that screen into each axis of a print apparatus reference frame, the first length and the second length; and
a screen selection module to test each screen for moiré effect.

12. Processing circuitry according to claim 11 wherein the screen selection module is to retain screens which are associated with a moiré effect below a threshold and discard screens which are associated with a moiré effect above the threshold.

13. Processing circuitry according to claim 11 wherein the screen generation module is to generate the plurality of halftone screens such that each screen comprises tiles having a first and a second side length, where the first and the second side length span a non-negative integer number of the first and the second lengths of the cells of that screen.

14. A non-transitory machine readable medium comprising instructions which, when executed by a processor, cause the processor to:
determine a non-orthogonal halftone screen comprising tiles spanning a plurality of halftone cells having a print addressable area of variable size, the halftone cells comprising non-orthogonal parallelograms being defined by a first vector having a first length and second vector having a second length;
determine first and second fundamental frequencies for the halftone screen using a projection of the first and of the second vector into each axis of a print apparatus reference frame, the first length and the second length; and
use the first and second fundamental frequencies to determine if the halftone screen is associated with perceptible moiré effects.

15. The non-transitory machine readable medium of claim 14 further comprising instructions which, when executed by the processor, cause the processor to:
combine a plurality of screens and test the combinations of screens to determine if the screen is associated with perceptible moiré effects.
